(19) United States
(12) Patent Application Publication
(10) Pub. No.: US 2010/0238985 A1
(43) Pub. Date: Sep. 23, 2010

(54) Cellular Uploader for Digital Game Camera

(76) Inventors: John Traywick, Hoover, AL (US); Daniel Ulrich, Hamilton, OH (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/577,459

(22) Filed: Oct. 12, 2009

Related U.S. Application Data
(60) Provisional application No. 61/114,182, filed on Nov. 13, 2008.

(51) Int. Cl. H04B 1/38

(52) U.S. Cl. 375/220

(57) ABSTRACT

A communications device for communicating digital data from an electronic device, such as a game camera or a game feeder, to a central administrative server via a machine to machine network, such as a cellular telecommunications network. More specifically, the present relates to a cellular uploader that is programmed via software to communicate data between a digital camera and a server hosting a game management website.

### RELATED APPLICATIONS

This application claims priority from U.S. Provisional Patent Application No. 61/114,182 Entitled: “Cellular Uploader for Digital Game Camera” filed Nov. 13, 2008 and is related to co-pending U.S. patent application Ser. No. 12/261,685 Entitled: “Solar-Charged Power Source” filed Oct. 30, 2008 and co-pending U.S. patent application Ser. No. 12/560,779 entitled “Method for Monitoring a Predetermined Photographed Area Via A Website” filed Sep. 14, 2009, all of which are incorporated herein by reference.

### FIELD OF THE INVENTION

This invention relates to a system and a method for communicating digital data from an electronic device, such as a game camera, to a central administrative server via a machine to machine network, such as a cellular telecommunications network. More specifically, the present relates to a cellular uploader that is programmed via software to communicate data between a digital camera and a server hosting a game management website.

### BRIEF DESCRIPTION OF THE DRAWINGS

FIG. 1 is a block diagram of the system described herein;

FIG. 2A is a block diagram of cellular uploader for digital equipment;

FIG. 2B is a block diagram of an alternative embodiment of a cellular uploader for digital equipment;

FIG. 2C is a block diagram of an alternative embodiment of a cellular uploader with a commercially available modem module;

FIG. 3 is a block diagram illustrating the communications between the electronic equipment and the cellular uploader;

FIG. 4 is a flow chart illustrating uploader data communications within the system;

FIG. 5A is a perspective exterior view of the uploader;

FIG. 5B is a rear exterior view of the uploader, and,

FIG. 6 is a schematic of a camera interface board.

### DETAILED DESCRIPTION OF THE PREFERRED EMBODIMENTS

Referring to the drawings for a clearer understanding of the invention, a system 10 having one or more uploaders 12 connected to various electronic devices, such as digital game camera 14 and game feeders 16, to transmit data and information to a central administrative server 22 which maintains a website for customers to view and store their data, such as pictures and camera settings, online as further described in commonly owned and co-pending U.S. patent application Ser. No. 12/560,779 referenced hereinabove.

The uploader 12 of the system includes a cellular modem 30 that has been adapted to work in conjunction with the electronic devices and equipment. It will be appreciated that the cellular modem may be replaced with any other wireless medium that allows digital information to be transferred to and from electronically controlled game management devices.

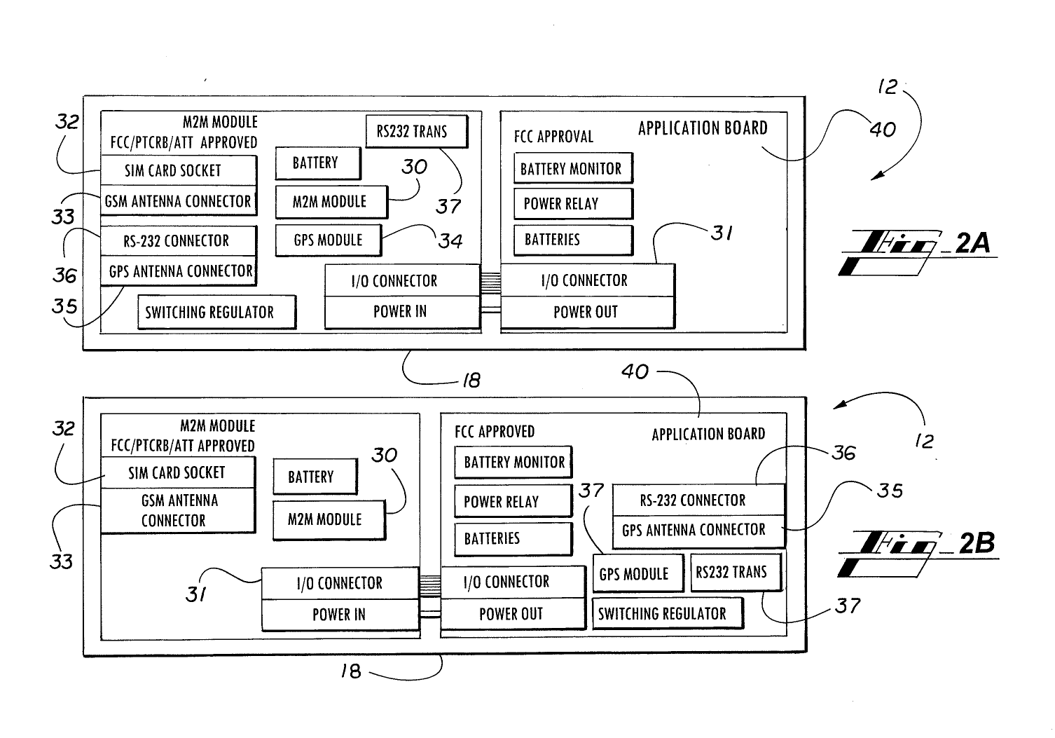

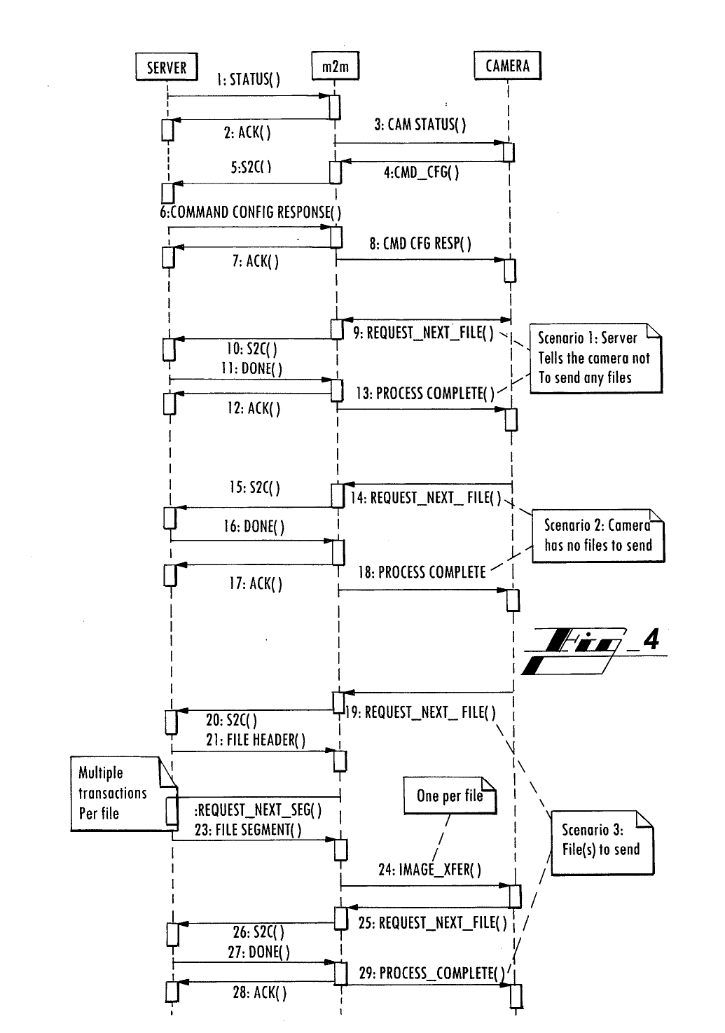

Referring to FIG. 2A, the uploader 12 includes a machine to machine (M2M) modem 30, which may be any FCC/PTCRB/ATT approved device for communicating on a M2M network 20, such as a cellular telecommunications network exemplified by the Global System for Mobile Communication (GSM) for communications between the uploader 12 and the server 22. The components of the uploader 12 are contained in a ruggedized enclosure 18, such as shown in FIGS. 5A and 5B, suitable to protect the electronic components from exposure to the elements in the environment in which the device is utilized. The modem 30 can be a custom configured printed circuit board with an M2M chipset, integrated with other components of the uploader 12 on the same board, such as shown in FIGS. 2A and B, or the modem 30 may be an off-the shelf M2M communications device such as the Wavecom Fastrack Supreme as shown in FIG. 2C, operatively connected to an application board 40, via an RS-232 connection 31 between the modem 30 and the application board 40. Other elements of the modem 30 include a subscriber identity module (SIM) card socket 32 when necessary for operation of the device on the M2M network 20 and modem antenna connector 33 and antenna 133. The uploader 12 will also include a GPS chipset 34 and associated GPS antenna connector 35, which may be configured on the application board 40, as shown in FIG. 2A. Alternatively, the GPS chipset 34 and GPS antenna connector 35 may be integrated in the modem 30, such as depicted in FIG. 2B. A GPS antenna 138 is integrated with enclosure 18. The uploader 12 is connected to the electronic devices such as digital camera 14 or electronically controlled game feeder 16 using a connection 36 such as an RS-232 interface, USB, Bluetooth, or another known electronic connection, used to transmit and receive electronic signals between the digital camera 14 or game feeder 16 and the uploader 12. In FIGS. 5A & 5B an RJ-45 communication cable 136 is shown. An interface module 37, such as an RS-232 translator is included for translating data communications between of the modem and attached electronic equipment such as digital camera 14. A control unit 38 with software controls uploader 12.

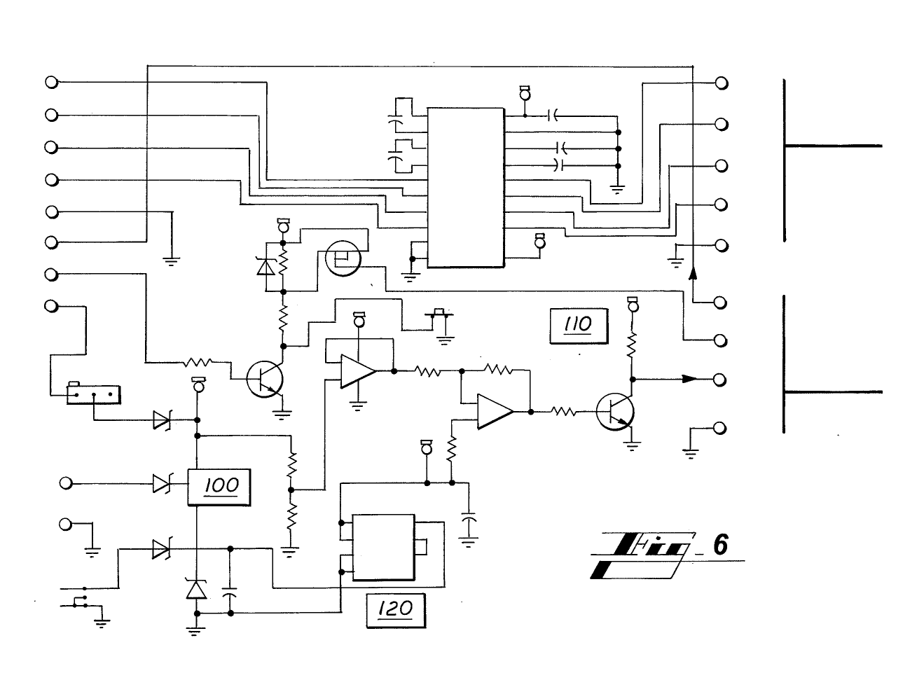

Referring to FIG. 6, the device interface board is illustrated as a camera interface board which will be similar for other chosen devices such as feeders. The board includes Camera RS-232 transceiver chip 1, such as a MAX3223, with hardware flow control, and over voltage protection for solar panel/ext. power, connection for local power and camera power. Input for local batteries 2; Input for camera power 4; Input for external power (ex. Power Panel) 5; Camera turn-on/off modem control 6; Modem wake-up camera signal 7 which is a direct connection across the board from the modem; Low voltage detection 8 with an output to the modem; a switch 9 giving the ability to enable/disable power source from camera; isolation to prohibit back-feed from one power source into another 100; A switch 110 providing Ability to override the camera's on/off control; Voltage regulator for RS-232 transceiver 120. It is to be understood that the circuit shown in FIG. 6 is an example and the actual circuit may vary.

The uploader 12 is portable, and can be moved from electronic device to electronic device as desired by the owner. Data stored in a memory on the digital camera 14 is communicated via a universal asynchronous receiver/transmitter (UART) and an input/output port controlled by the digital camera 14. Since the uploader 12 is a portable module it allows a single customer to buy a single unit and use it in multiple locations according to what the user would like to monitor.

In operation, the user will connect the uploader with the desired electronic device (e.g., a digital camera 14) and place it in a condition to receive remote communications from the server 22 via an M2M network 20. Communications between the uploader 12 and the digital camera 14 are established through the interface module 37 for converting the CMOS data received from the digital camera 14 and translating data received from the server 22 to the digital camera 14, where subsequent transmission of the data between the uploader 12 and the server 22 is via HTLM/SMS messages. During initial power on of the system, communications will be initiated between the uploader 12 and the digital camera 14, when the interface module 37 detects the operational status between the devices. Messages communicated between the digital camera 14 and the interface module 37 are in 8-bit unsigned bytes. Digital camera 14 to interface module 37 message formats are shown in the following Table 1:

TABLE 1

| | Byte | Value |
|---|---|---|
| 1 | STX | 0x02 |
| 2 | MSG BODY LEN LSB | LSB - number of bytes in MSG BODY |
| 4 | MSG BODY LEN MSB | MSB - number of bytes in MSG BODY |
| 5 | ERROR INDICATOR | 0 = No Errors |
| | | 1 = File Error |
| | | 2 = Read Error |
| | | 3 - Unexpected Request for Next Segment |
| 6 | IMAGE SIZE LOW | 0 |
| 7 | IMAGE SIZE MIDDLE | 0 |
| 8 | IMAGE SIZE HIGH | 0 |
| 9 | CHECKSUM | 8 bit sum, ignore carry of bytes in |
| | | message starting with Message Type |
| | | (inclusive) and ending with last byte of |
| | | Message Body (inclusive) |
| 10 | ETX | 0x03 |

Example interface module 37 to digital camera 14 message formats are shown in the following Table 2:

TABLE 2

| Byte | Value |
|---|---|
| STX | 0x02 |
| MSG TYPE | Server-to-Camera Message = 0x20 |
| | Request Next File Segment = 0x21 |
| | Server Down = 0x22 |
| | ACK = 0x23 |
| | NAK = 0x24 |
| MSG BODY LEN LSB | Based on number of bytes in MSG BODY |
| MSG BODY LEN MSB | Based on number of bytes in MSG BODY |
| RETRY SECS | A server setting based on response time - the |
| | number of seconds the Camera should wait |
| | for a message (excluding ACK, NAK, etc.) |
| | before retrying. |
| MAX MSG BODY | The maximum message body size times ten |
| LEN * 10 | (for images) between the camera nad the |
| | module and the module and the server should |
| | be the same. This allows the module to |
| | dictate the size and the camera to follow. For |
| | example, if the max message size is 1000, this |
| | value would be 100. |
| MSG BODY | Per |
| CHECKSUM | 8 bit sum, ignore carry of bytes in message |
| | starting with Message Type (inclusive) and |
| | ending with last byte of Message Body |
| | (inclusive) |
| ETX | 0x03 |

During the power up sequence four conditions are sensed by the RI. Where the uploader 12 power is turned on by the digital camera 14, which presumes an operative connection, the interface module 37 will supply a 300 μs pulse on the RI and should detect a camera status message within 5 seconds. If the uploader 12 is turned on by the user and there is no digital camera 14 operatively connected to the uploader 12, the interface module 37 will not detect a camera status message within 5 seconds and will assume that the digital camera 14 is not connected. If the interface module power is turned on by the user and there is an digital camera 14 connection, the module will supply a 300 μs pulse on the RI and detect a camera status message within 5 seconds. If the interface module 37 power is on with the uploader 12 in a low power mode, and still monitoring the UART and GPRS, if an SMS message is received from the server 22, (such as indicating a user changed setting for the camera), the interface module 37 supplies a 300 μs wake-up pulse on the RI line to restore the uploader 12 to a full power mode.

In addition to the power on sequences, communications between the uploader 12 and the digital camera 14 may be initiated based on the condition of events programmed into the camera software. Communications can be based on a programmed date time group in order to transmit image data based on the time settings programmed into the digital camera 14 by the user through server 22. Alternatively, communications may be initiated on the condition of an event such a new image being taken by the digital camera 14 when this feature is enabled via software settings.

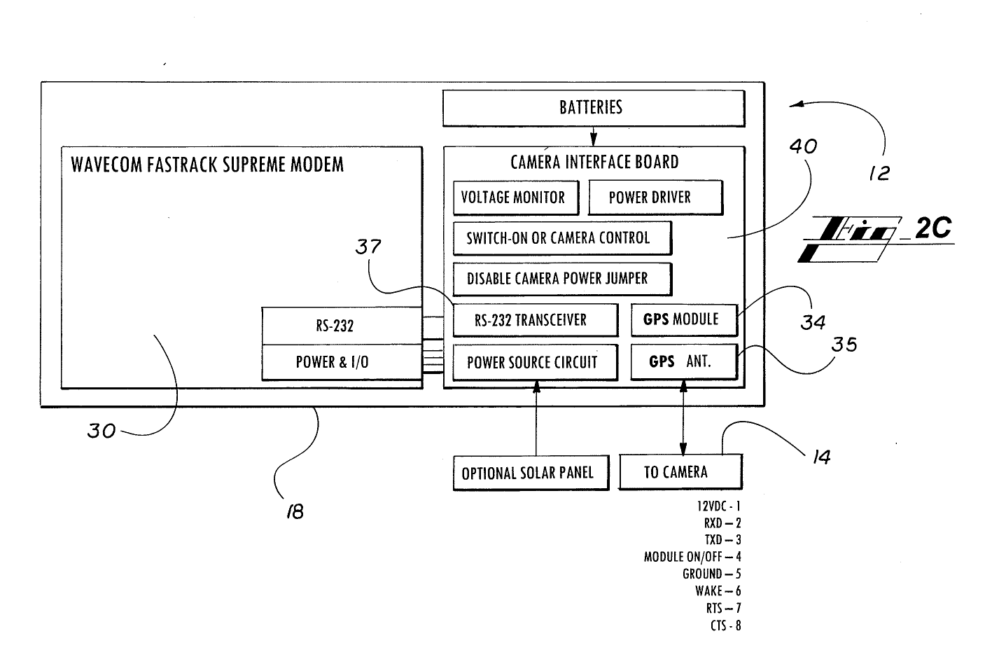

In reference to FIG. 3, illustrating a flowchart of system functions for transmitting and receiving data between the digital camera 14 and the uploader 12, once the digital camera 14 and uploader 12 are placed in an operational condition, the modem 12 will then establish a connection to a third party M2M network 20. The modem 12 sends a request for image data to the digital camera 14. Once the connection is established, the modem will transmit the pictures and GPS data (as well as any other data generated at the field site) to the server 22 via the M2M network, and the uploader 12 will receive a confirmation from the server 22 that the data has been successfully transmitted and received. The digital camera 14 can be programmed to transmit the image data, as either an individual image or a batch of images to the uploader 12. The uploader 12 retrieves GPS data from the GPS chipset 34 and attaches the data to the image data for transmission to the server 22. The modem 30 establishes communications with the server 22 via the M2M network 20 and after confirming communications with the server 22, the uploader transmits the image and GPS data to the server 22. When the server 22 has successfully received the image data, it sends a confirmatory message to the uploader 12.

In addition, the uploader 12 may receive messages from the server 22 to change settings in the modem 30 or digital camera 14. If changes are necessary, the uploader 12 will send the camera an XML file to update the camera's settings if needed. The uploader 12 may then be programmed via software to go into a sleep/power save mode for an interval set by the user, such as a predetermined time or predetermined period of time since the last communication. The uploader 12 may also be programmed to check for the presence of new images stored in the memory installed in the digital camera 14. If the digital camera 14 has taken any new pictures, the uploader 12 will once again request the new picture data from the digital camera 14 and repeat the steps noted above.

Example interface module 37 to server 22 message formats are shown in the following Table 3:

TABLE 3

| Message Name | CMD_NM | Description |
|---|---|---|
| Camera Status | CAM_STATUS | M2M module sends camera's status |
| Command and Configuration | CMD_CFG | Server responds with User Commands |
| | | (conditional - if any commands were |
| | | set by the user) and Configuration |
| | | (conditional - if the configuration was |
| | | changed by the user. |
| Command and Config | CMD_CFG RESP | M2M module sends the Command and |
| Response | | Config Response (conditional - if |
| | | command was received in the INIT |
| | | message) Camera Configuration. |
| Transfer next image file | REQ_NXT | Server responds with the results from |
| request | | previous message (IMAGE_XFR or |
| | | CMD_CFG_RESP) and requests next |
| | | file (if applicable). |
| Image Transfer | IMAGE_XFER | M2M module sends a file |
| Process Complete | DONE | M2M module sends a process complete |
| | | message to the Server and the Server |
| | | does not respond. |

As contemplated by the invention the GPS chipset 34 determines GPS coordinates of the unit, and the uploader software will attach the GPS coordinates to a picture or batch of pictures as they are uploaded to the central administrative server 22, thereby reducing the quantity of data that is required to be communicated to the server 22. The uploader 12 may additionally include optional sensors (not shown) to monitor various desired factors, such as time, temperature, humidity, barometric pressure. Sensors may be integrated within or attached externally to the digital camera 14, the game feeder 16 or the uploader 12. Depending upon the type of data sensed by sensors the sensed data may be attached to the batch of uploaded pictures or the individual pictures may be tagged with the data.

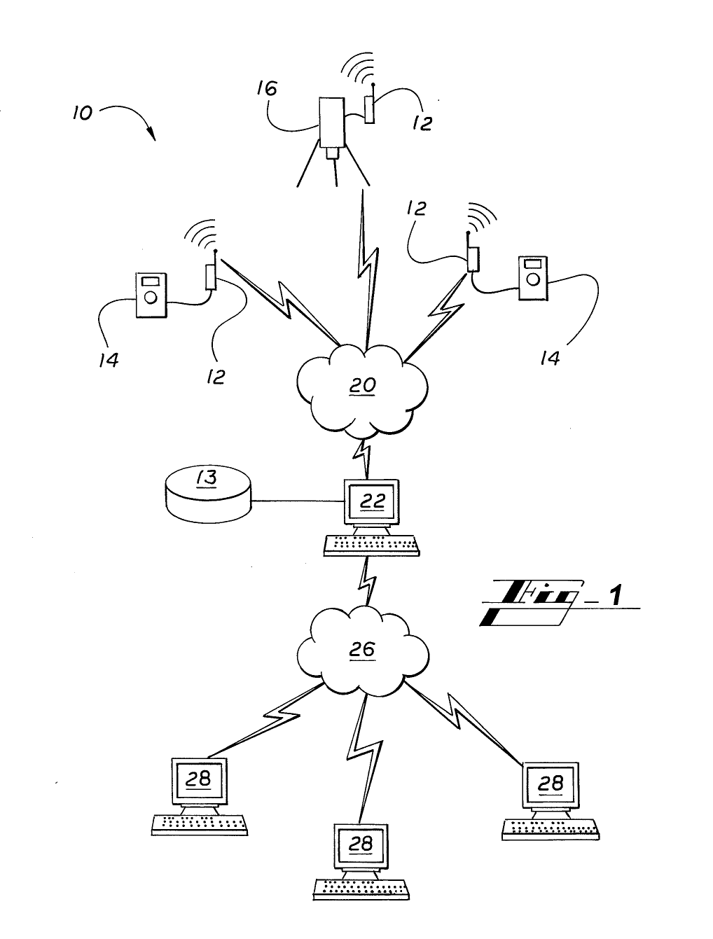

As is shown in FIG. 1, the user, using any electronic device 28 (such as a personal computer, PDA or similar device) able to access the website via a global computer network 26, can access images stored on a database 13 and may also set uploader 12 and digital camera 14 settings via the website maintained by the central administrative server 22.

As contemplated by the invention, data communications between the uploader 12 and the server 22 is via Hypertext Transfer Protocol (HTTP), including: an HTTP application layer; a transport layer TCP; an IP network/internet layer; and a GPRS/EDGE data link layer. The HTTP communication uses named value pairs initiated from the M2M module 30.

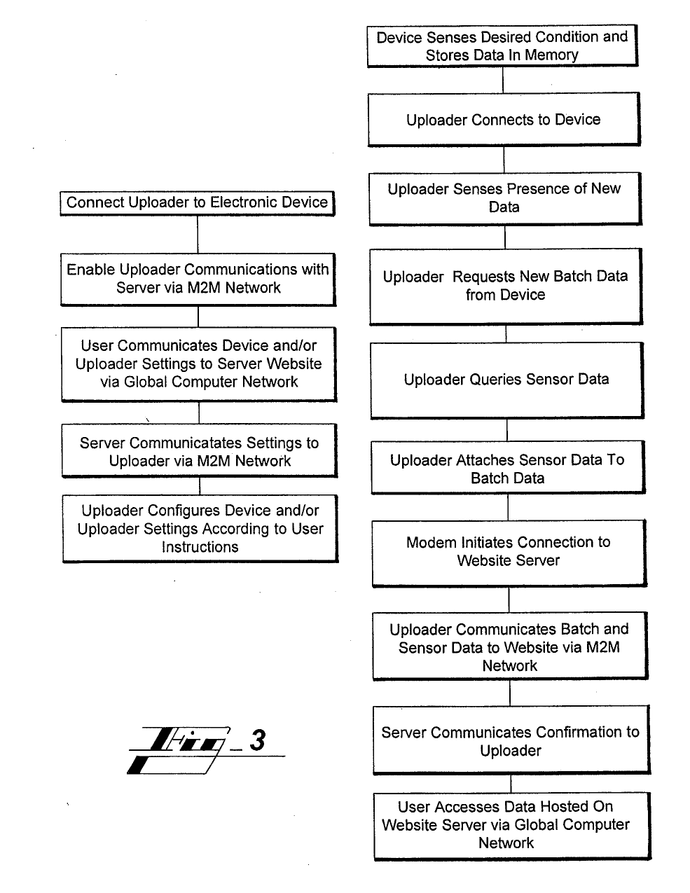

Examples of data communications between the server 22 the uploader 12 and the uploader 12 and the digital camera 14 are illustrated in FIG. 4. As previously discussed, communications between the digital camera 14 and the server 22 may be initiated on conditions such as: during the camera's power on sequence, at a specified date time group based on server settings received by the digital camera 14, on the occurrence of a new image being taken by the digital camera 14 when enabled by the user, or upon receipt of a wake-up signal received by the uploader 12. A camera initiated communication of camera status information to the server 22 is illustrated in lines 1-8. An example of a server initiated request to change camera settings is illustrated in lines 9-13, as indicated in Scenario 1. In this instance the server 22 instructs the digital camera 14 not to send any files. In Scenario 2, shown in lines 14-18, the server 22 requests that the digital camera 14 send files to the server 22, but the digital camera 14 communicates data indicating it has no files to send. In Scenario 3, a server 22 request to the digital camera 14 to transmit files is illustrated at lines 19-29, in which the digital camera 14 transmits multiple to the server 12.

In a typical command to request camera status, CAM_STATUS, the server 22 will request status information from a selected uploader 12, identified in the HTTP request body by its unique International Mobile Subscriber Identity (IMSI) number. The uploader 12 will populate the variables responsive to the server status request which will include the uploader's IMSI number, and may include the GPS data, camera status, battery life. GPS data may include the operational status of the GPS receiver such as a GPS hardware fault, an indication that the GPS is operational but is unable to establish a fix, and an indication that the GPS is operational and has established a fix. Additional GPS data would include the GPS determined latitude, longitude, altitude, number of visible satellites received, and the time the GPS signal was acquired. The uploader 12 will also populate camera connection status data including conditions such as, not connected, connected, connected but error present, based on the communications link established between the uploader 12 and the digital camera 14. Where the uploader 12 has been programmed and configured with a battery level metering capability, the uploader 12 will also populate battery level data for the uploader 12, for example a percentage of battery life remaining, and may also include a battery low indication may be a Boolean true or false data element.

Data populated by the digital camera 14 and communicated to the uploader 12 would include a message sequence number indicating the message request number. Where an event counter is present in the digital camera 14, the digital camera 14 would also populate an event count, indicating the number of events that have occurred since the last time the event counter was cleared. A camera memory status may include both the total number of bytes of camera memory and the number of bytes currently used in the camera's memory. The digital camera 14 will also indicate the camera battery level. Because the uploader 12 may be moved and connected to different cameras, it is desirable that the digital camera 14 for a given location have some identifying indicia. Accordingly, the digital camera 14 may populate the request body with a unique identification number associated with the digital camera 14, or a user defined name for the digital camera 14. Camera status information populated by the camera will also include the image count indicating the number of photos the camera has to send.

On an initial power-up sequence the server will transmit system default configuration parameters as a response to the camera status request via the uploader 12. The responsive message body would include the command name, or error if there is a problem with the server or identification of the IMSI number. The server will also provide a status code indicating success, a fatal system error, or a system fine but IMSI error. The response would also include an action command to the uploader 12, such as upload all files, delete all files, reset the event counter, or configuration updates according to user defined instructions. Initial power-up configuration data would also include transmission of a date time setting to synchronize the digital camera 14 and/or uploader 12 time with the server 22. As previously described, the server 22 may also establish the next transmission time according to user defined date time group, or upon the expiration of a user specified number of minutes. The uploader 12 will transmit an response confirming the configuration settings with the server 22, which the server acknowledges

Other user defined settings may also be configured by the user through the server 22 and transmitted to the digital camera 14. Where the digital camera 14 provide such features, the user defined configuration settings may also include: a user defined name for the camera; an image resolution setting; a single or multi-shot mode; a flash setting; enabling image uploading; delete file after upload; immediate image upload after image capture; an image delay count; image information stamping; remote control enable; camera lock; temperature; time lapse variables; capture mode such as video or still imaging; video length where a video capture mode is selected.

In initiating an image file transfer, the uploader 12 will populate the HTTP message request header with the IMSI number and the digital camera 14 will populate data for the sequence number for the message request, the camera identification number, the image size of the image being sent; the size of the next image if transmitting in a batch mode, and the image count indicating the total number of photos the digital camera 14 has to transmit. The request body will contain the bytes of the file if there is a file to send. The server response header will request the next image, echo the sequence number; a system status code; the number of bytes received from the uploaded file; and a an indication that the uploader 12 is clear to send another image.

The uploader 12 of the present invention includes both the programming software and hardware to establish communications between the uploader 12 an electronic device such as a digital camera 14 as well as the necessary programming software and cellular modem capability to communicate image data captured by the digital camera 14 to a centralized server 22 via an M2M cellular telecommunications network.

It should be appreciated that when the electronically controllable device is a game feeder 16, then the command and communication structure will be somewhat different than that required to retrieve digital images from a camera. It should also be understood that a feeder can be controlled to vary the amount of feed by changing the time the feeder motor runs remotely and that the level of food remaining in the feeder can be determined by sensors in the feeder structure. Thus, a user may note from the information transmitted to the website that his current rate of dispensing feed will cause the feeder to empty before he can get to it to refill it. By using the uplink in conjunction with the feeder he can reduce the rate of dispensing feed to give him additional time to get to the feeder without having a period of time when no feed is being dispensed. By using the multiple sensors available as described above, the user may elect to vary the feed rate based on weather conditions, moon phase or other conditions and can easily do so using the uploader 12. That is to say in the case of a game feeder 16, the uplink can communicate operational parameters of the game feeder 16, such as battery life, fill level or the amount of food remaining in the feeder, to the user via the central server 22. Similarly, the user can communicate control signals to uplink unit, and thereby the feeder to control such parameters as feed rate, or to set or adjust dispensing times and schedules.

Referring to FIG. 5B it will be seen that enclosure 18 is provided with a pair of external brackets 181 that mate to a mounting bar which can be attached to the support structure holding the electronic device, such that the uploader 12 can be supported on the bracket and connected to the device using cable 136. This provides a secure mounting for the uploader when it is desired to leave the uploader connected to monitor a specific electronic device, yet allows the uploader to be easily detached from the specific device and moved to another device.

While the invention has been shown and described in preferred forms, it will be apparent to those skilled in the art that many modifications, additions, and deletions can be made therein without departing from the spirit and scope of the invention.

What I claim is:

1. An apparatus for enabling wireless communication between one or more digital devices disposed at a predetermined location and a wire-less network based monitoring system including a server, wherein the apparatus comprises:
An electronic interface for selective electronic connection to a digital device selected from said one or more digital devices, said interface including connection for one or more of device power, external power, device turn-on/off modem control, Modem wake-up device signal, Low voltage detection, override of the device's on/off control, and digital image transfer;
A modem selected for compatibility with a wireless network operatively connected to said electronic interface, whereby said apparatus may be transported to a digital device selected from said one or more digital devices s at different locations and connected thereto to enable communication between said selected digital device and said server.

2. An apparatus as defined in claim 1 wherein at least one digital device selected from one or more digital devices is a digital camera.

3. An apparatus as defined in claim 2 further comprising a global positioning sensor having an output indicating the geographic location of said apparatus when connected to a digital device selected from said one or more digital devices such that said geographic location can be digitally transmitted via said modem to said server.

4. An apparatus as defined in claim 1 further including means for releasably securing said apparatus proximal one or more of said digital devices for prolonged remote monitoring of said device with said apparatus, whereby said apparatus may be released and reattached proximal another of said digital devices for selective communication between said another of said digital devices and said server.
